(19) United States
(12) Patent Application Publication
(10) Pub. No.: US 2018/0120422 A1
(43) Pub. Date: May 3, 2018

(54) LOW COST AND COMPACT OPTICAL PHASED ARRAY WITH ELECTRO-OPTIC BEAM STEERING

(71) Applicant: Quanergy Systems, Inc., Sunnyvale, CA (US)

(72) Inventors: Junichiro Fujita, Sunnyvale, CA (US); Louay Eldada, Sunnyvale, CA (US)

(21) Appl. No.: 15/342,958

(22) Filed: Nov. 3, 2016

(51) Int. Cl. G01S 7/481; G01S 7/486

(52) U.S. Cl. CPC G01S 7/4818; G01S 7/4865; G01S 7/4817

(57) ABSTRACT

An apparatus has an input waveguide to receive light. An optical power splitter is connected to the input waveguide to form split signals. An array of waveguides receives the split signals. A phase tuning region includes electrodes within a cladding structure surrounding cores of the array of waveguides. The phase tuning region produces an electro-optic effect under the control of a phase tuning control circuit applying an electric field to the electrodes to render phase difference split signals within the array of waveguides. Output array waveguides emit the phase difference split signals as steered beams based on relative phase differences among the phase difference split signals.

### FIELD OF THE INVENTION

The present invention relates to the field of spatial sensing using Time of Flight (ToF) LIDAR sensors. More particularly, the invention is a low cost and compact optical phased array ToF LIDAR sensor with electro-optic beam steering.

### BACKGROUND OF THE INVENTION

Optical phased arrays (OPAs) have been studied for manipulating a small optical beam (e.g., a laser beam). OPAs represent an evolution of well-developed radio frequency (RF) counterparts, namely Phased Array Radar. Several groups studied optical phased arrays based on various technologies, such as liquid crystal (LC), microelectromechanical systems (MEMS) and optical waveguide devices.

One application of OPAs is a Light Detection and Ranging (LIDAR) sensor for automotive systems. For example, a LIDAR sensor positioned on a vehicle collects information on objects around it while in motion. The collected information characterizes objects and live events around the vehicle. It is desirable that a LIDAR sensor steer an optical radiation pattern across a wide scanning angle, such as 50 degrees or larger, while the divergence angle needs to be small (e.g., on an order of 1 mrad) to minimize the spot size of the beam scan. It is also desirable that this type of sensor be compact enough not to effect the vehicle appearance or aerodynamics. Preferably, there are no moving parts associated with the sensor. Further, any device for an automobile application requires minimal power consumption and low cost.

One way to realize OPAs is based on planar lightwave circuits (PLC's) where beams are confined within optical waveguides. U.S. Pat. No. 5,233,673 discloses an electro-optic material that uses lithium niobate. This design is based on an input waveguide into which laser light is coupled, one-to-multiple optical power splitters and an array of output waveguides where phase is controlled. This design has a practical limitation in terms of steering angle because of the channel spacing at the array of output waveguides. That is, relatively large output channel spacing is required to minimize electrical crosstalk. Also, lithium niobate waveguides may not be the best approach in terms of volume manufacturing and overall cost.

Optical phased arrays based on silicon waveguide chips are known. These designs are based on an input waveguide where laser light is coupled into one-to-multiple optical power splitters, phase shifters, and an array of out-of-plane couplers which emit light from the surface of the chip. The location of phase tuning has been separated from the array of output waveguides, which makes it possible to achieve narrow channel spacing and related wider steering angle of up to 51°. Also, low manufacturing cost is obtained through the use of complementary metal-oxide-semiconductor (CMOS) processes. However, these techniques use heaters to create relative phase differences among the array of waveguides. That is, the beam steering requires heater power for each channel. Thus, this technique requires thermal management. In addition, overall power consumption may be difficult in automotive applications.

### SUMMARY OF THE INVENTION

An apparatus has an input waveguide to receive light. An optical power splitter is connected to the input waveguide to form split signals. An array of waveguides receives the split signals. A phase tuning region includes electrodes within a cladding material surrounding cores of the array of waveguides. The phase tuning region produces an electro-optic effect under the control of a phase tuning control circuit applying an electric field to the electrodes to render phase difference split signals within the array of waveguides. Output array waveguides emit the phase difference split signals as steered beams based on relative phase differences among the phase difference split signals.

### BRIEF DESCRIPTION OF THE FIGURES

The invention is more fully appreciated in connection with the following detailed description taken in conjunction with the accompanying drawings, in which:

FIG. 1 is a top view of an optical phased array configured in accordance with an embodiment of the invention.

FIG. 2 is a cross-sectional view of an optical phased array configured in accordance with an embodiment of the invention.

FIG. 3 is a cross-sectional view of an optical phased array configured in accordance with an embodiment of the invention.

Like reference numerals refer to corresponding parts throughout the several views of the drawings.

### DETAILED DESCRIPTION OF THE INVENTION

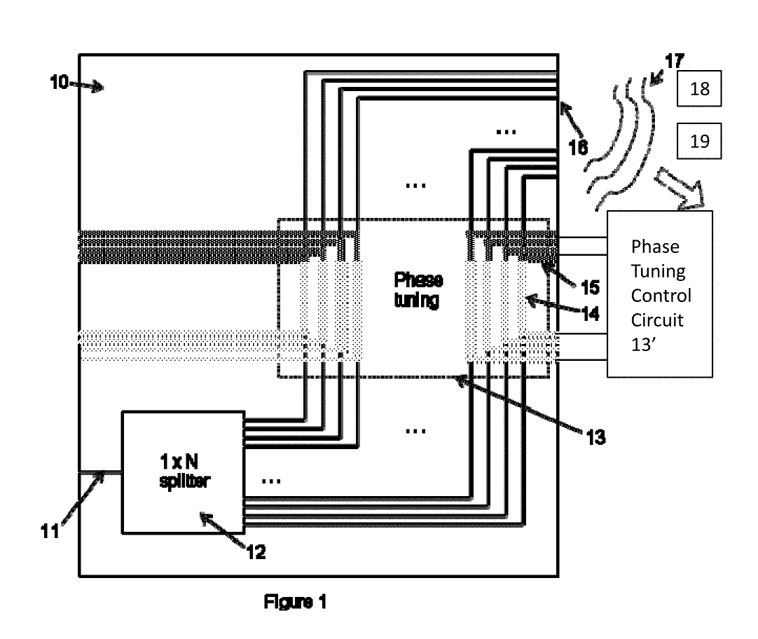

The schematic diagram of FIG. 1 depicts the top view of an optical phased array. It is based on a substrate 10 with a waveguide input 11 where light from an external source is coupled. Alternately, an integrated light source may be used to generate the light. The light is split by one or more optical power splitters 12 to form split signals. An array of waveguides receives the split signals. The array of waveguides includes a phase tuning region 13 which includes electrodes 14 and 15. The electrodes 14 and 15 induce an electro-optic effect in said array of waveguides in said phase tuning region 13 based upon a phase tuning control circuit 13′.

At the phase tuning region 13, the waveguide spacing is selected so that device elements such as electrodes and trenches can be fabricated within the region. Also, a large waveguide spacing, such as>10 μm, is designed for minimizing the electrically related crosstalk within the array of waveguides. Thus, the waveguide spacing in the phase tuning region is an order of magnitude larger than the operating wavelength of the split signals.

The light that travels through the phase tuning region 13 is delivered to an array of output waveguides 16. The waveguide spacing of the output waveguides 16 is selected to define the maximum beam steering angle. The output waveguide spacing is typically designed to be as small as possible and selected based on the maximum optical coupling allowed for the device. As such, the spacing of the output array waveguides 16 is substantially smaller than the waveguide spacing in the phase tuning region 13.

The output beam, 17 is steered based on the relative phase difference among the output waveguides 16. More particularly, the phase tuning region 13 produces an electro-optic effect under the control of the phase tuning control circuit 13′, which applies an electric field to the electrodes 14, 15 to render phase difference split signals within the array of waveguides. The output array waveguides 16 emit the phase difference split signals as steered beams based on relative phase differences among the phase difference split signals.

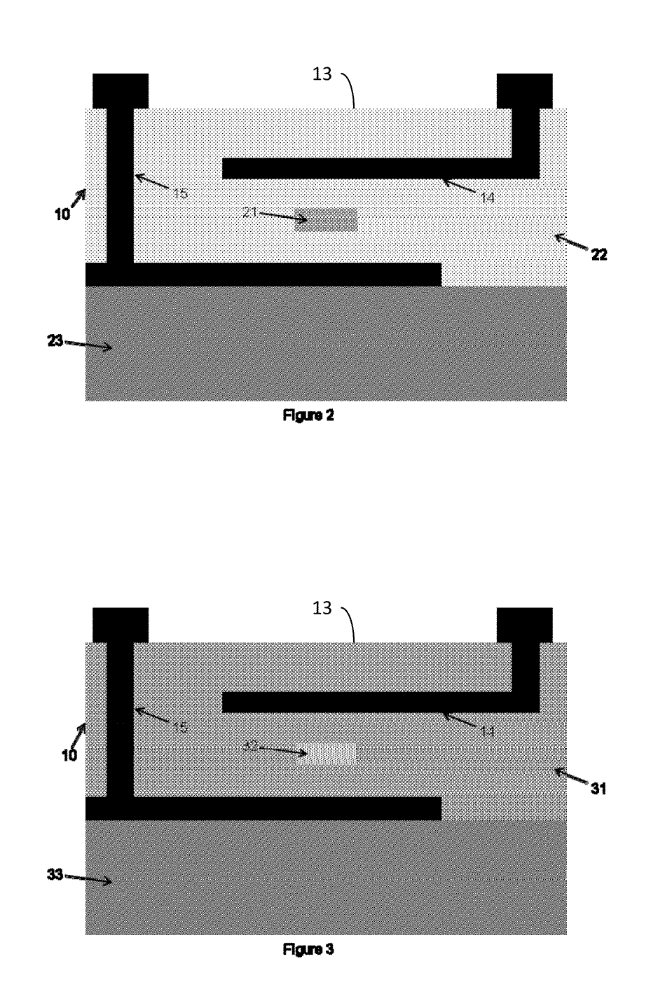

The schematic diagram of FIG. 2 depicts a cross-sectional view of an optical phased array chip 10 at phase tuning region 13 for the case of aluminum nitride (or gallium nitride) 21 as the waveguide core material. The aluminum nitride waveguide core is surrounded by a cladding material, 22, typically silicon dioxide. The electrodes 14 and 15, typically made of aluminum or highly doped silicon, are deposited to create an electric field across the waveguide core 21. Aluminum nitride has a dielectric tensor which creates a refractive index change based on the orientation of the electric field. The direction of the electric field is chosen to create a large enough refractive index change within the limited operation range such as the maximum voltage across the electrodes. The layers are fabricated on a substrate 23, which is typically chosen to be silicon.

The schematic diagram of FIG. 3 depicts the cross-sectional view of an optical phased array chip 10 at phase tuning region 13 for the case of a cladding material 31 of aluminum nitride (or gallium nitride). The material of the waveguide core 32 is designed to have a higher refractive index than aluminum nitride (or gallium nitride). The electrodes 14 and 15 are deposited to create an electric field across the waveguide core 32. The electric field creates a refractive index change in the cladding layer 31 that affects the phase of the guided mode propagating through the waveguide core 32. The waveguide structures are fabricated on a substrate, 33, which is typically chosen to be silicon.

The disclosed structure is an optical beam steering device which forms multiple beams steered based on the relative phase difference among the output waveguides. The design is based on an optical phased array on photonic integrated circuits (PICs), so that the device is compact and has no moving parts. Advantageously, the electro-optic effect does not cause thermal management problems as with prior art heaters used to create relative phase differences within an array of waveguides. While prior art heaters result in relatively large power consumption (e.g., on the order of a Watt or more), the disclosed device has minimal power consumption (e.g., substantially less than a Watt).

The concept of steering based on an optical phased array is similar to steering based on RF antenna elements in a Phased Array Radar. A beam is formed from an array of waveguides and is steered along the array of waveguides based on the relative phase difference among the light signals within the waveguides. The maximum steering angle of a main beam and the divergence angle are expressed by:

Ψₛₜₑₑᵣ=asin(π/d)

Ψ_{divergence}˜π/(d×N×π)

where N is the number of output waveguides and d is the channel spacing of the waveguides. Note also that the number of steered beams (a main beam that steers within −0.5Ψₛₜₑₑᵣ and 0.5Ψₛₜₑₑᵣ and the higher order beams shifted from the main beam by an increment of Ψₛₜₑₑᵣ) is closely related to the ratio of the mode field diameter within a waveguide to the waveguide spacing and is larger than one. Overall, a design to realize an optical phased array along the array of waveguides can be done by properly choosing the waveguide spacing, the number of array waveguides, and the mode field diameter of each waveguide.

Silicon waveguides are attractive because these devices can be fabricated with low-cost CMOS-compatible processes. These OPAs have been demonstrated with 16 output waveguides with thermo-optic tuning. In order to improve the divergence angle, the larger number of output waveguides where the phase of each waveguide can be controlled is necessary. The thermo-optic tuning dissipates heat near and on a silicon substrate, which may disrupt device operation. In addition, thermo-optic tuning increases power consumption. Consequently, the ability to scale up from 16 output waveguides is limited.

To overcome these limitations, the disclosed technology chooses an electro-optic material that can be fabricated with a CMOS compatible process. One example is aluminum nitride (AlN). Aluminum nitride has a linear electro-optic coefficient equivalent to other semiconductor materials commonly used for phase tuning and can be grown on CMOS compatible materials such as silicon dioxide. Crystalized aluminum nitride is a uniaxial material and is typically grown so that the optical axis is out-of-plane and with in-plane isotropy. In this case, the electro-optic coefficient of r₁₃ and/or r₃₃ and out-of-plane electric field can be used to achieve the refractive index change. The refractive index change can be expressed as:

n=nₒ×r×nₒ³×E_{z}/2

where nₒ is the refractive index in absence of electric field, r is the electro-optic coefficient (r₁₃ or r₃₃ depending on the polarization), and E_{z} is the electric field across the electro-optic material.

Returning to FIG. 1, disclosed is a PIC on a substrate 10 with an input waveguide 11 that accepts light from a laser. The light from the input waveguide 11 goes into the 1×N optical power splitting section 12 where light is split into N waveguides. The phase tuning section 13 creates phase shifts for N waveguides so that the desired beam steering is achieved. The tuning may occur based on a pair of electrodes 14 and 15 which run across the waveguides containing an electro-optic material. The phase-tuned light from N waveguides exits at 16 with a steering angle based on the relative phase difference among N waveguides. Since the phase tuning of each waveguide is physically separated from the output waveguides 16, the waveguide spacing of the output waveguides is not limited by elements, such as electrodes 14 and 15, needed for phase tuning. Therefore, a wide range of steering angles is available with this invention. The output beam 17 is steered at an angle determined by the relative phase difference among the waveguides 16. Integrated out-of-plane couplers may be used for the output beam 17, such as a grating 18 or angled mirror 19.

FIG. 2 depicts the cross-sectional view of the present invention at the phase tuning section 13. For the case of aluminum nitride as the electro-optic material and as the waveguide core 21, the waveguide structure can be designed so that the electric field will be created in the vertical direction. The electro-optic waveguide 21 is sandwiched by a pair of electrodes 14 and 15. The cladding 22 is made of a material that enables the deposition of both the core material and the electrodes 14, 15. A typical material for the cladding 22 is silicon dioxide. For devices based on CMOS processes, the substrate 23 is silicon, while the electrodes 14 and 15 can be aluminum, highly doped silicon, or any other fabrication compatible metal.

FIG. 3 also depicts the cross-sectional view of the present invention at the phase tuning section 13. An electro-optic material is used for the cladding 31. Since the propagating mode extends beyond the waveguide core, the electro-optic effect at the proximity of the core will affect the mode propagation and equivalently its phase. The core 32 does not need to be made of electro-optic material, but needs to have a larger refractive index than that of the cladding 31. An example of the core material is titanium dioxide. Electrodes 14 and 15 are placed across the core layer 32. The substrate 33 may be formed of Silicon.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. An apparatus, comprising:
an input optical waveguide to receive light;
an optical power splitter connected to the input optical waveguide to form split signals;
an array of waveguides to receive the split signals;
a phase tuning region including electrodes within a cladding structure surrounding cores of the array of waveguides, wherein the phase tuning region produces an electro-optic effect under the control of a phase tuning control circuit applying an electric field to the electrodes to render phase difference split signals within the array of waveguides; and
output array waveguides to emit the phase difference split signals as steered beams based on relative phase differences among the phase difference split signals.

2. The apparatus of claim 1 wherein the waveguide spacing in the phase tuning region is an order of magnitude larger than the operating wavelength of the split signals.

3. The apparatus of claim 2 wherein the waveguide spacing in the output array waveguides is substantially smaller than the waveguide spacing in the phase tuning region.

4. The apparatus of claim 1 wherein the steered beams have a steering angle of approximately 50 degrees or more.

5. The apparatus of claim 1 wherein the steered beams have a divergence angle of substantially less than 1 degree.

6. The apparatus of claim 1 wherein the electrodes are metal. The apparatus of claim 1 wherein the electrodes are highly doped silicon.

8. The apparatus of claim 1 wherein the cladding and the cores of the array of waveguides are made of electro-optic materials.

9. The apparatus of claim 1 wherein the cladding is made of aluminum nitride and the array of waveguides is made of a material with a larger refractive index than aluminum nitride.

10. The apparatus of claim 1 wherein the cladding is made of gallium nitride and the array of waveguides is made of a material with a larger refractive index than gallium nitride.

11. The apparatus of claim 1 wherein the cores of the array of waveguides are made of aluminum nitride.

12. The apparatus of claim 1 wherein the cores of the array of waveguides are made of gallium nitride.

13. The apparatus of claim 1 wherein the cores of the array of waveguides are made of a mixture of aluminum nitride and gallium nitride.

14. The apparatus of claim 1 further comprising a silicon substrate.

15. The apparatus of claim 1 further comprising an integrated light source to generate the light.

16. The apparatus of claim 1 further comprising integrated out-of-plane couplers.

17. The apparatus of claim 16 wherein the integrated out-of-plane couplers include a grating.

18. The apparatus of claim 16 wherein the integrated out-of-plane couplers include an angled mirror.
